(19) United States
(12) Patent Application Publication
(10) Pub. No.: US 2008/0072281 A1
(43) Pub. Date: Mar. 20, 2008

(54) Enterprise data protection management for providing secure communication in a network

(76) Inventors: Ronald B. Willis, Apex, NC (US); Charles Rodney Starrett, Cary, NC (US)

Correspondence Address: TRIANGLE PATENTS, P.L.L.C., P.O. BOX 28539, RALEIGH, NC, 27611-8539, US

(21) Appl. No.: 11/900,260

(22) Filed: Sep. 11, 2007

Related U.S. Application Data
(60) Provisional application No. 60/844,484, filed on Sep. 14, 2006.

(51) Int. Cl. G06F 21/00

(52) U.S. Cl. 726/1

(57) ABSTRACT

System and methods for providing an intelligent overlay for providing dynamic control policies, keys and management of same for secure communication of information, data and/or communication over a network without requiring any change in the network hardware or infrastructure and requiring a minimum number of policies and SAs to create a full mesh, wherein the number of policies is less than N(N−1) and number of SAs is less than 2N(N−1), where N is the number of end points on the network.

### CROSS-REFERENCE TO RELATED APPLICATIONS

This non-provisional utility patent application claims the benefit of provisional application Ser. No. 60/844,484, filed Sep. 14, 2006, which is incorporated herein by reference in its entirety.

### BACKGROUND OF THE INVENTION

1. Field of the Invention

The present invention relates generally to secure communication and/or interaction between points in a network. More particularly, the present invention relates to an enterprise data protection management system and methods for providing dynamic control policies, keys and management of same for a data communications network using a single policy and two secure associations (SAs).

2. Description of the Prior Art

Generally, current security solutions for networks include discrete solutions provided by security software and encryption algorithms and keys generated therefrom, network infrastructure, information technology (IT) infrastructure, and other enabling infrastructure, such as those provided by hardware and software for particular applications, as illustrated in FIG. 1 (Prior Art). Typically, changes to security solutions and even modifications within an existing security solution for a network requires complex adaptation and changes to the existing infrastructure, or are so cumbersome that use of encryption and security throughout most network activity is not commercially feasible or manageable, following a general formula requiring the number of policies to be N(N−1) where N is the number of end points, and, correspondingly, the number of secure associations being N(N−1)2, as illustrated in FIG. 6 Prior Art. Clearly, as the number of end points increases, the number of policies and SAs quickly becomes impractical and unmanageable; however, this is the state of the art for traditional data protection on a network.

By way of example, current practice for providing secure group communications is represented by US Patent Application Publication No. 2004/0044891 for “System and method for secure group communications” by Hanzlik et al. published on Mar. 4, 2004 relating to implementation of a virtual private network group having a plurality of group nodes, a policy server, and shared keys for sharing encrypted secure communication information among the group nodes.

Thus, there remains a need for flexible, dynamic software-based security solutions that overlay onto existing network architecture without requiring complex changes to the hardware and network, IT and/or enabling infrastructure and that require a minimum number of policies and secure associations between points on the network to create a full mesh for secure communication, data access, or other secure activity.

### SUMMARY OF THE INVENTION

The present invention provides flexible, dynamic software-based security solutions that overlay onto existing network architecture without requiring complex changes to the hardware and network, IT and/or enabling infrastructure, and which provide a multiplicity of end point secure associations (SAs) and configuration options with a minimum number of policies and SAs, preferably requiring only one policy and two SAs to provide a full mesh network for secure communication thereon.

A first aspect of the present invention is to provide an enterprise data policy management system for providing secure networks using an automated software overlay that dynamically controls the policy, key, and secure association (SA) management that is adaptable to existing network architectures without requiring changes to the hardware and network, IT and/or enabling architecture, and while simultaneously minimizing the number of policies and SAs require to manage the secure communication. In one embodiment, the EDPM system includes a communication network having a network infrastructure; and an intelligent software overlay operating on a server in connection to the network for providing security for the network; wherein the intelligent software overlay further includes: a management and policy (MAP) server coupled to the network for communication with at least one key authority point (KAP), wherein the MAP includes at least one policy for providing secure association (SA) within the network; wherein the at least one KAP is operable to generate and manage keys provided to a multiplicity of policy end points (PEPs) through an open API; and wherein the intelligent overlay to the network is independent of the network infrastructure and requires a minimum number of policies that is less than N(N−1) and number of SAs is less than 2N(N−1), where N is the number of end points, thereby providing a secure, flexible network security solution.

A second aspect of the present invention is to provide an intelligent overlay software for providing dynamic control policies, keys and management of same for a data and/or communications network that is operable without changing the network infrastructure and is scalable without requiring an increase in the number of policies and corresponding SAs for the same configuration or architecture.

The present invention is further directed to a method for managing a dynamic network security solution including the steps of providing an intelligent overlay having centralized control policies, keys and management; applying the software overlay onto a data and/or communications network; implementing the policies and SAs without requiring any change in the network hardware or infrastructure and without requiring an increase in the number of policies and corresponding SAs required to ensure security for a given configuration between points on the network.

Thus, the present invention provides an intelligent, dynamic security solution for enterprise data management that is applicable to complex networks without affecting existing infrastructure or hardware configurations and that is scalable without requiring an increase in the number of policies and corresponding SAs.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a schematic of general PRIOR ART network security system arrangement.

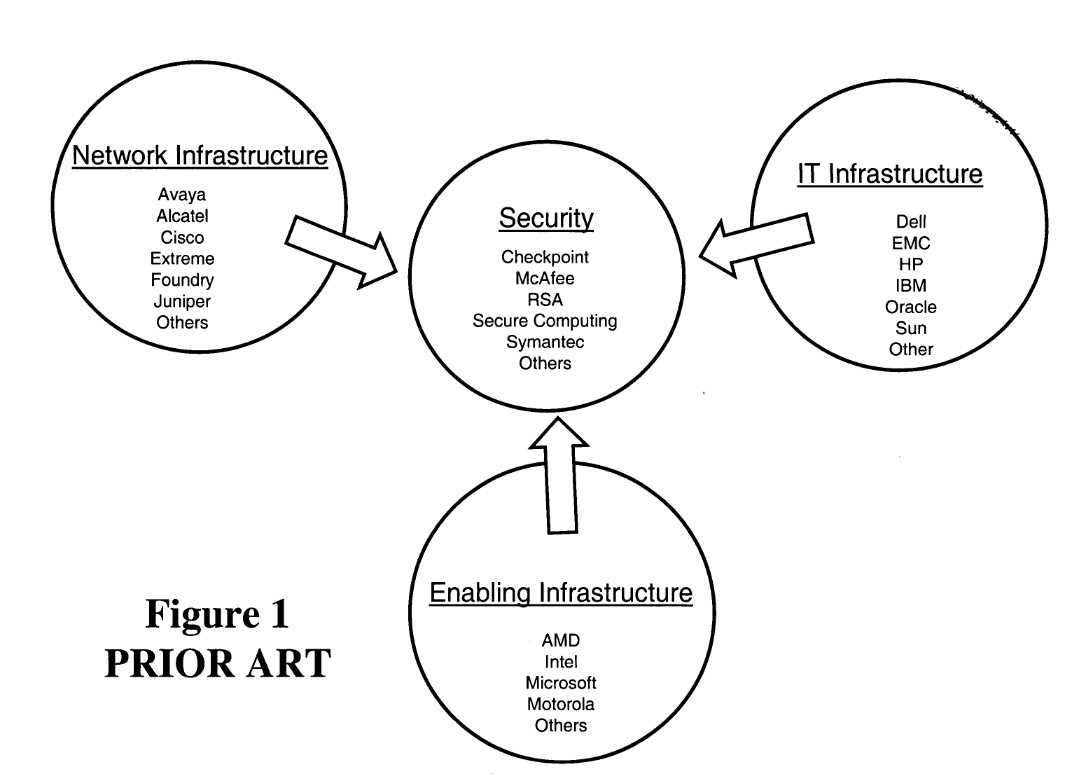

FIG. 2 is a schematic showing a centralized software solution for providing and managing security for data and communications of a network in accordance with an embodiment of the present invention.

FIG. 3 is a schematic diagram for the intelligent overlay of the present invention, and the MAP, KAP, PEP components.

FIG. 4 is a schematic diagram showing universal KAP for network protection.

FIG. 5 is a schematic showing the KAP for universal on-demand key generation services for all security needs.

FIG. 6 is a schematic of PRIOR ART secure network mesh requirements.

FIG. 7 is a schematic of EDPM solution using the intelligent overlay according to the present invention.

FIG. 8 is a schematic of EDPM solution using the intelligent overlay for a full mesh architecture according to the present invention.

FIG. 9 is a schematic of EDPM solution using the intelligent overlay for a hierarchical structure according to the present invention.

FIG. 10 is a schematic of EDPM solution using the intelligent overlay for creating a multicast group according to the present invention.

FIG. 11 is a schematic of EDPM solution using the intelligent overlay for creating a broadcast group according to the present invention.

FIG. 12 is a schematic showing functional security groups across a network and geographic boundaries.

FIG. 13 is a schematic showing security group enforcement via MAP/KAP.

FIG. 14 is a schematic showing multiple integration points through APIs according to the present invention.

FIG. 15 is a schematic illustrating security groups and data protection with NAC server for one application embodiment of the present invention.

### DETAILED DESCRIPTION

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

As referred to herein, the term “encryption” includes aspects of authentication, entitlement, data integrity, access control, confidentiality, segmentation, information control, and combinations thereof.

The present invention provides a powerful key and policy management software-based solution that enables secure data access and user interactions, and that enables users to securely access and interact with data they need and are authorized to access on predetermined, regular, and/or transactional bases from any point on the network without requiring changes in the existing infrastructure. The intelligent overlay of the present invention controls and manages the establishment and activity for trusted, secure connections that are created by end point security technologies, such as, by way of example and not limitation, NAC, Virus Scanning, etc. This “soft” or flexible software solution layer or overlay does not require a separate infrastructure to affect changes in network access, key or policy management, and advantageously provides for increasing the number of PEPs without requiring an increase in the number of policies and corresponding SAs, based upon grouping the PEPs under the MAP/KAP administration.

Preferably, the system and methods of the present invention provide a network-independent solution layer or overlay that functions over the existing network infrastructure to control the policies, secure associations (SAs), and keys enabling secure communications and data access to authorized users at any point within the network; more particularly the system and methods of the present invention do so without requiring an increase in the number of policies and corresponding SAs by grouping PEPs under the MAP/KAP intelligent software overlay. Because the present invention establishes an independent solution layer or overlay that enables grouped PEP management, it provides for essentially unlimited scalability without requiring an increase in the number of policies and corresponding SAs and address management that is commercially practical to implement network-wide for all secure communication, data access, applications, and devices. Also, this flexible software overlay functions to provide dynamic modifications in real time without requiring changes to existing infrastructure or hardware. Ideally, for creating and managing a full mesh of PEPs over the secure network, the number of policies required is one, and correspondingly, then number of SAs required is two. Even where the number of PEPs increases, N does not where the MAP/KAP intelligent overlay manages them with groupings to provide N=1 regardless. Therefore, use and implementation of the present invention is not limited to traditional networking or infrastructure, and is fully scalable in a practically manageable policy/SA volume, regardless of network size.

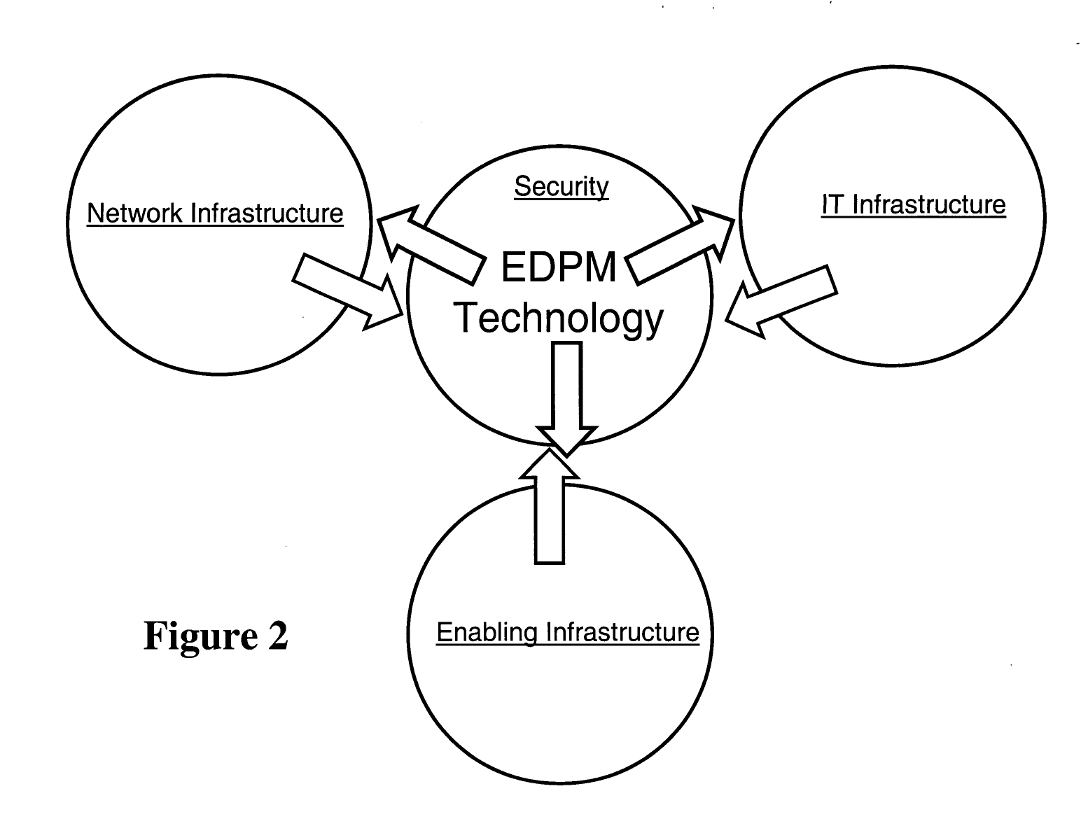

Referring now to the drawings in general, the illustrations are for the purpose of describing a preferred embodiment of the invention and are not intended to limit the invention thereto. As best seen in FIG. 2, a schematic shows a centralized software solution for providing and managing security for data and communications of a network in accordance with an embodiment of the present invention. The central node of this schematic provides the security of the network, wherein the EDPM (enterprise data protection management) technology includes the software overlay and becomes the central control and management solution for any network, without changing the network, IT, or enabling infrastructure represented by the outer nodes on this diagram. Within each of the nodes on this diagram, commercial product and/or software providers that are traditionally operating within those infrastructure areas are listed; these are representative of types of commercial providers in the space and are not intended to be limited thereto. This integrateable software security solution layer of the present invention enables centralized policy management, centralized key authority, group policy management with access control, universal key authority and distribution, open protocol via an intelligent overlay architecture for flexible and-dynamic changes that are independent of the infrastructure. Thus, the intelligent overlay software according to the present invention provides a transparent security utility for any network, but is also not limited to networks; while typically in this detailed description of the present invention the solution overlay is described for a network, in addition to network security, the overlay software solution is operable for entitlement, authentication, access control, data integrity, confidentiality, segmentation, information control, compliance, information and/or flows, applications, database access, storage networks, IT infrastructure, communications networks such as cellular, and combinations thereof in addition to network, data and communication security. Significantly, multiple security solutions can be combined together with the present invention overlay on a common infrastructure.

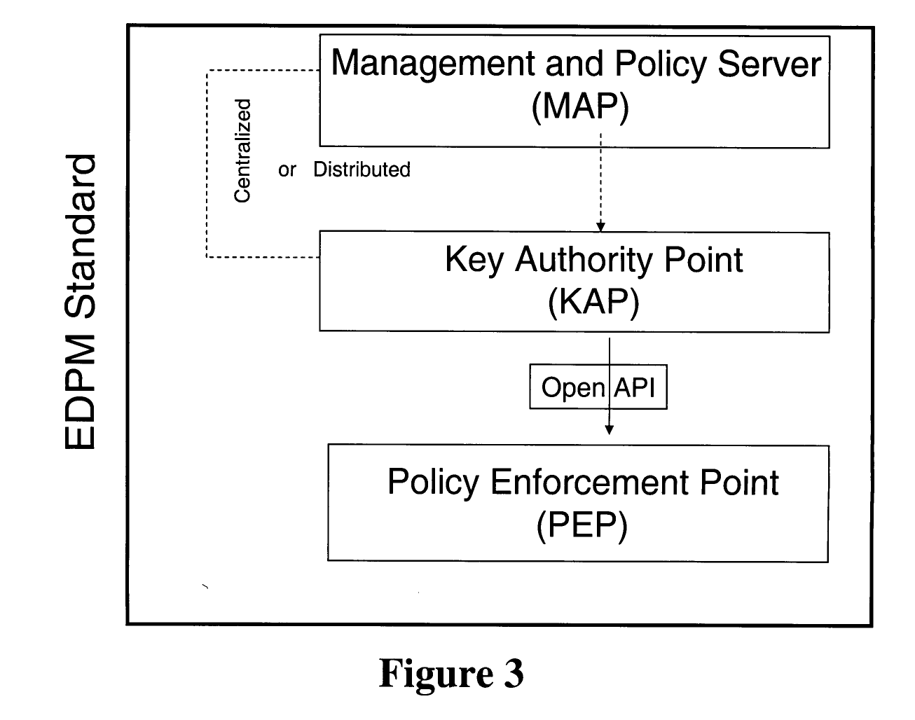

FIG. 3 shows a schematic diagram for the intelligent overlay of the present invention, including a management and policy server (MAP), at least one key authority point (KAP), that is designed to communicate through and open API to at least one policy enforcement point (PEP), wherein the MAP provides a centralized or distributed management arrangement having a single interface for policy definition and enforcement that operates to authenticate each PEP through existing AAA or other authentication services, and that pushes and enforces policy with the KAPs. The MAP is preferably centralized to coordinate policy and entitlements from one source, and ties in existing AAA services and NMS.

The KAPs function as a distribution layer; they are the key authority for the PEPs to generate and distribute security associations (SAs) and keys to PEPs, monitoring PEP operation, supporting tunnel, transport, and network modes, and allow distributed and redundant deployment of keys to PEPS, and combinations thereof. The PEPs are hardware or software-based PEPs, providing support for clients, blades, and appliances. The PEP policy and keys are enforced by the KAPs, while a PEP authenticates KAP. The KAP ensures that keys are sent only to the right places within the network, which provides for manageable scalability regardless of the number of PEPs or SAs required.

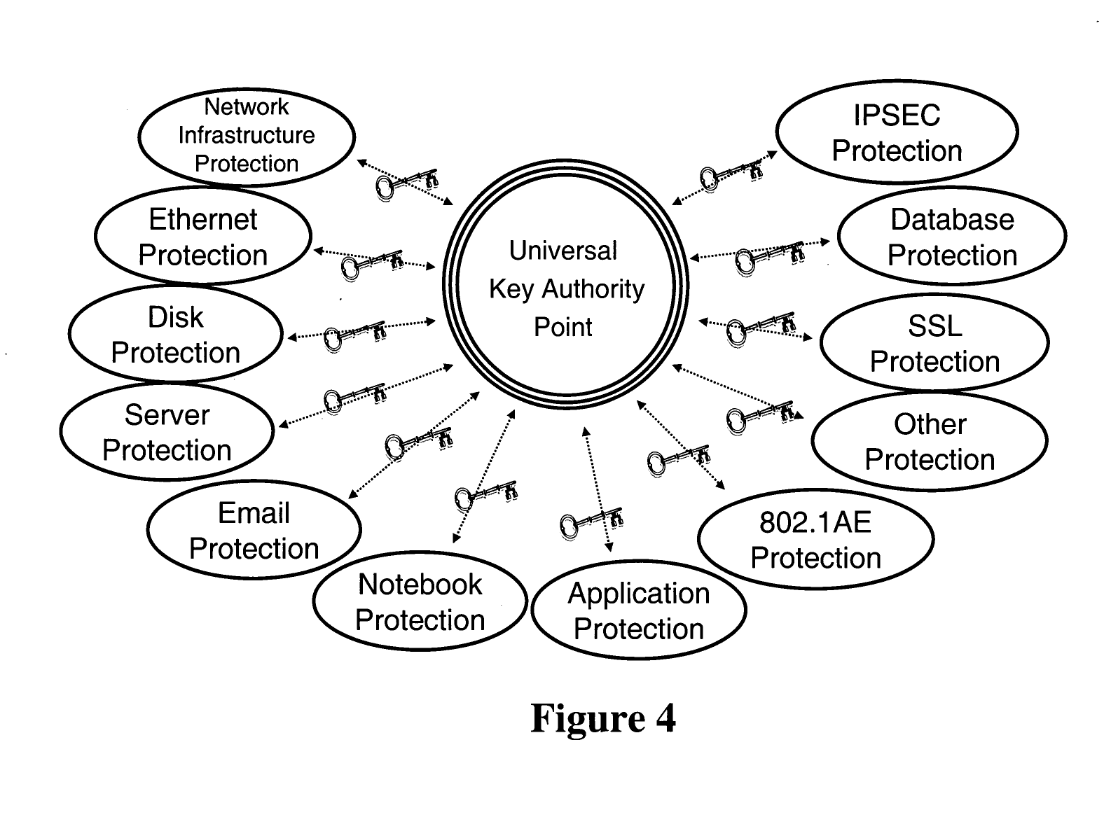

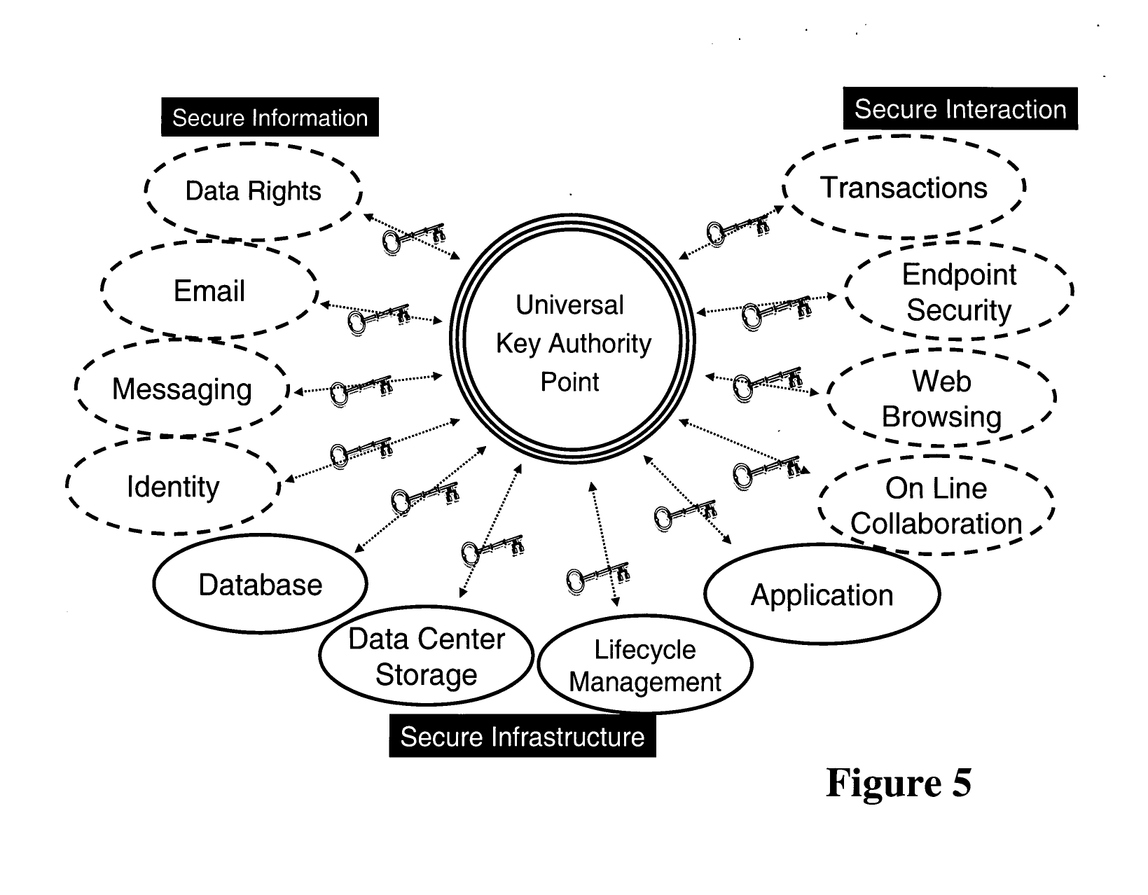

Furthermore, in a preferred embodiment of the present invention, the KAP is a universal KAP within the EDPM, and provides universal key generation and distribution services for the PEPs on the network. As such, the universal KAP ensures network infrastructure protection, Ethernet protection, disk protection, server protection, email protection, notebook computer protection, application protection, 802.1AE protection, IPSEC protection, database protection, SLL protection,.other protection and combinations thereof, as shown in the schematic of FIG. 4. According to the present invention, the KAP provides universal on-demand key generation services for all security needs, including secure information such as data rights, email, messaging, and identity; secure infrastructure such as database, data center storage, lifecycle management, and applications; and secure interaction such as transactions, endpoint security, web browsing, and on-line collaboration, and combinations thereof, as illustrated in the schematic of FIG. 5.

The software overlay solution ensures flexibility for multi-vendor support as illustrated in FIG. 2 representative vendors, wherein this support flexibility is designed in through API according to an embodiment of the present invention. Significantly, network security is enforced at every end point or PEP on the network level through an open API; PEPs include any end point, by way of example and not limitation, mobile devices such as PDAs, storage, servers, VPN clients, and networking, and combinations thereof.

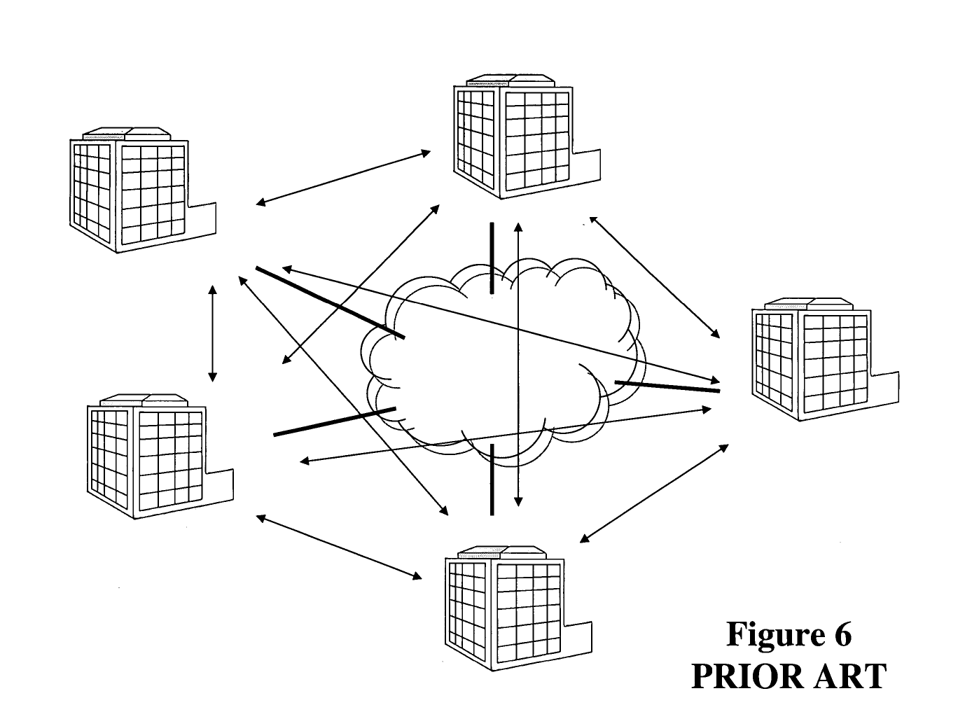

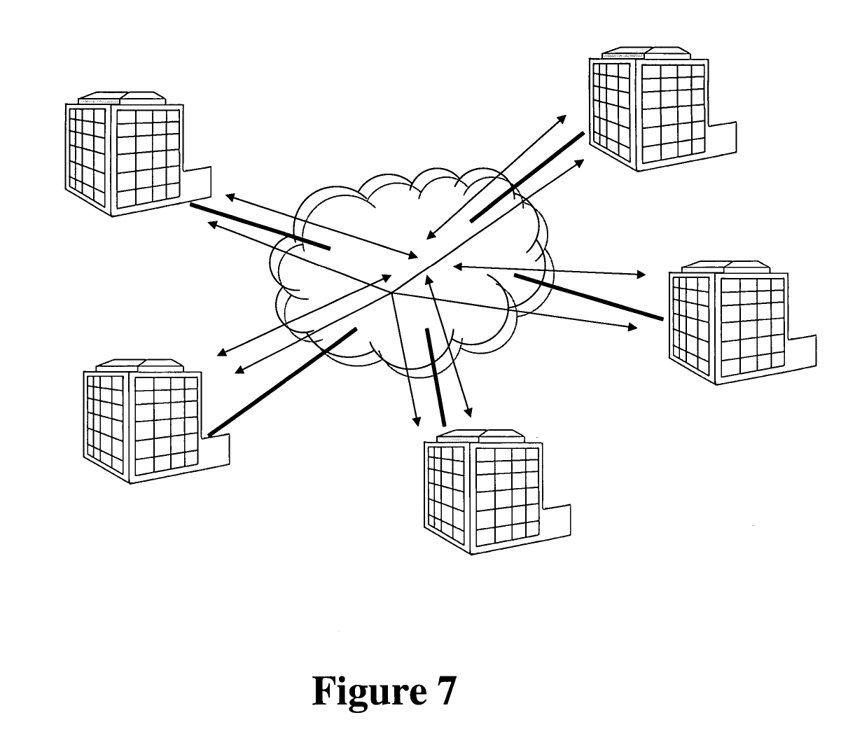

By sharp contrast to the prior art illustrated in FIG. 6 PRIOR ART, wherein encryption in traditional data protection requires a large number of policies to provide a full mesh of secure interconnectivity, twice that number of security associations (SAs) for the same, and significant change to the network is required, the intelligent overlay for secure networks according to the present invention using EDPM requires a small, limited number of policies and SAs for a full mesh, and no change to the network infrastructure is required, as illustrated by the schematic of FIG. 7. FIG. 7 is an important figure illustrating the ideal case where N=1 such that the number of policies and SAs required for a full mesh is minimized.

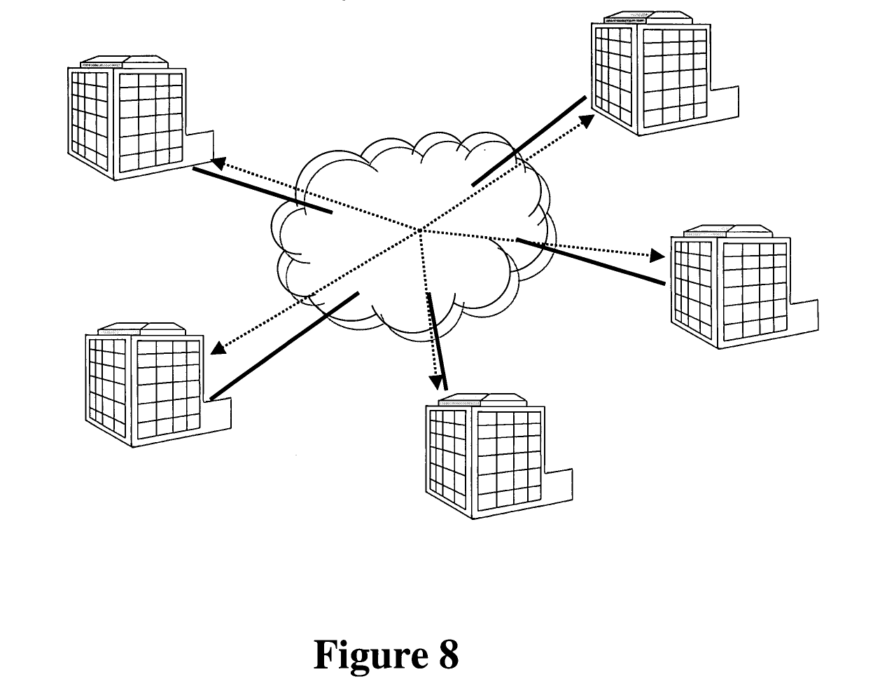

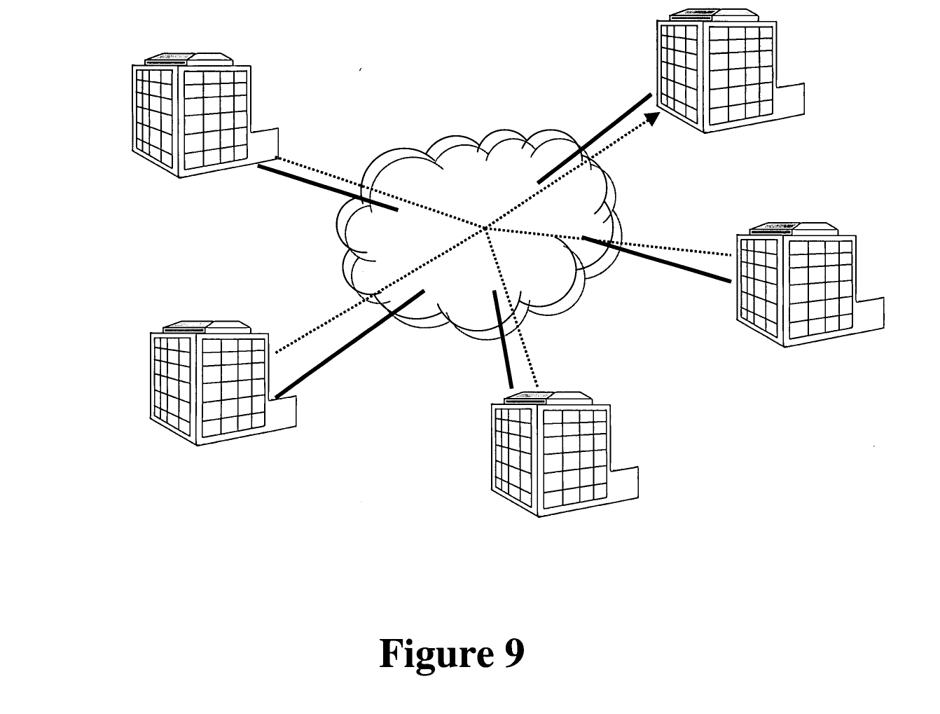

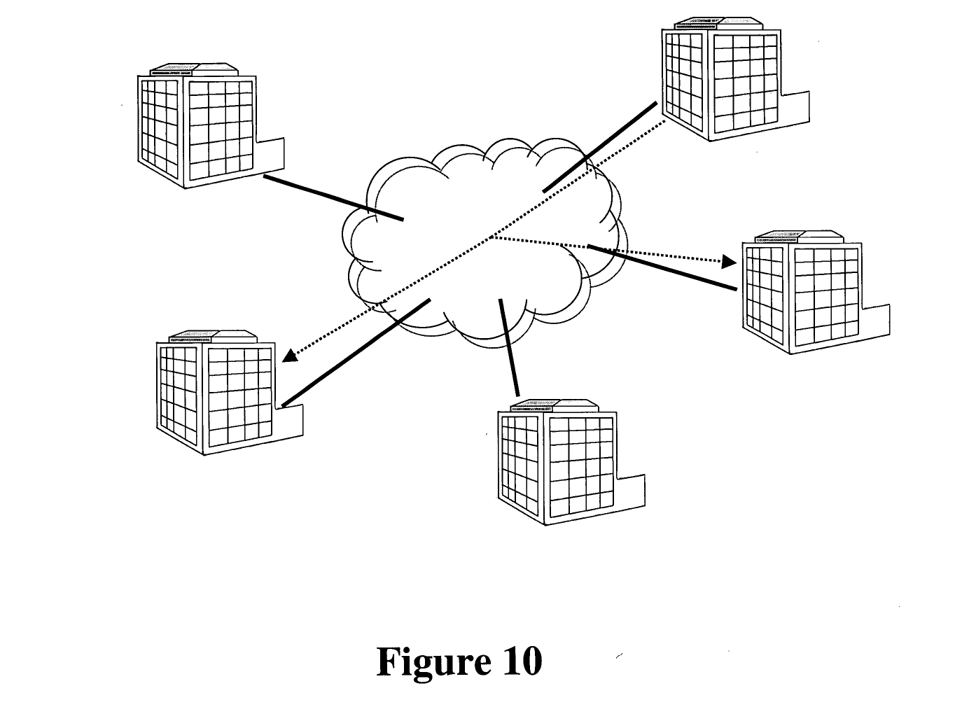

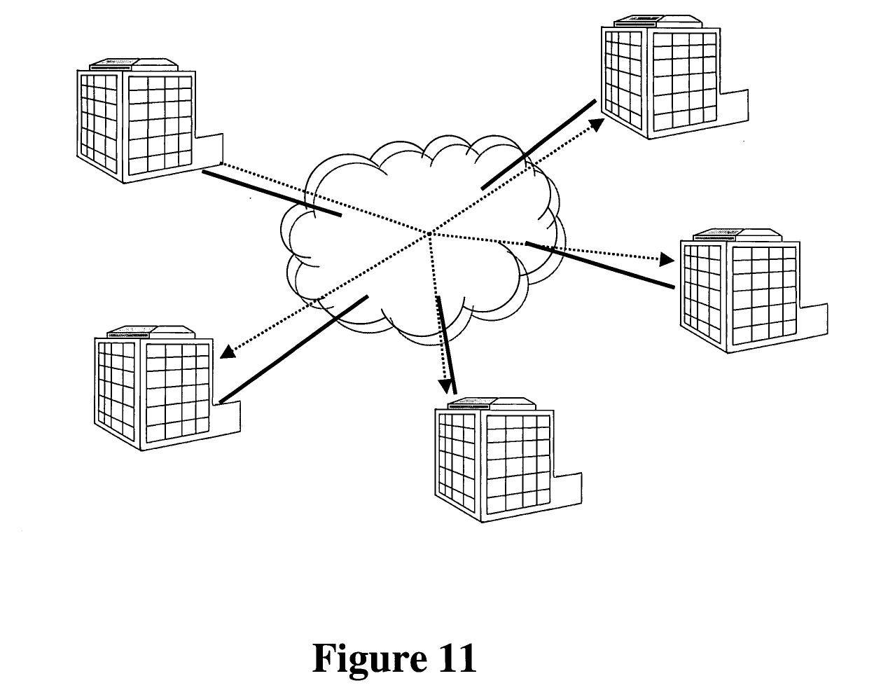

FIGS. 8-11 illustrate alternative configurations of PEP secure interactivity managed by the MAP/KAP and intelligent overlay software without requiring change to the network infrastructure. Specifically, FIG. 8 is a schematic of EDPM solution using the intelligent overlay for a full mesh architecture according to the present invention; FIG. 9 is a schematic of EDPM solution using the intelligent overlay for a hierarchical structure according to the present invention; FIG. 10 is a schematic of EDPM solution using the intelligent overlay for creating a multicast group according to the present invention; and FIG. 11 is a schematic of EDPM solution using the intelligent overlay for creating a broadcast group according to the present invention. The system is operable to change configurations based upon policies under the MAP/KAP and based upon the PEP authentication and requirements for data and network access.

Thus, the present invention provides a system for providing secure networks including a communication network having a network infrastructure; and an intelligent software overlay operating on a server in connection to the network for providing security for the network; wherein the intelligent software overlay further includes: a management and policy (MAP) server coupled to the network for communication with at least one key authority point (KAP), wherein the MAP includes at least one policy for providing secure association (SA) within the network; wherein the at least one KAP is operable to generate and manage keys provided to a multiplicity of policy end points (PEPs) through an open API; wherein the intelligent overlay to the network independent of the network infrastructure; and wherein the intelligent overlay to the network is independent of the network infrastructure and requires a minimum number of policies and SAs to create a full mesh, wherein the number of policies is less than N(N−1) and number of SAs is less than 2N(N−1), where N is the number of end points, thereby providing a secure, flexible network security solution. This intelligent overlay provides centralized management by software over the hardware and network infrastructure without changing it, and is fully scalable and dynamically modifiable to reconfigure secure PEP interactivity without requiring change to the network infrastructure, without requiring an increase in the number of policies and corresponding SAs.

The present invention also provides a method for providing secure interactivity between points on a network including the steps of:

providing a communication network having a network infrastructure between at least two policy end points (PEPs);

providing an intelligent software overlay that is independent of the network infrastructure, the software overlay operating on a server in connection to the network for providing security for the network; wherein the intelligent software overlay further includes: a management and policy (MAP) server coupled to the network for communication with at least one key authority point (KAP);

the MAP establishing and managing at least one policy for providing secure association (SA) between PEPs within the network;

the KAP generating and managing keys and providing them to the PEPs through an open API;

and the PEPs having secure exchange over the network using the keys provided by the KAP; wherein the intelligent overlay to the network is independent of the network infrastructure and requires a minimum number of policies and SAs to create a full mesh, wherein the number of policies is less than N(N−1) and number of SAs is less than 2N(N−1), where N is the number of end points.

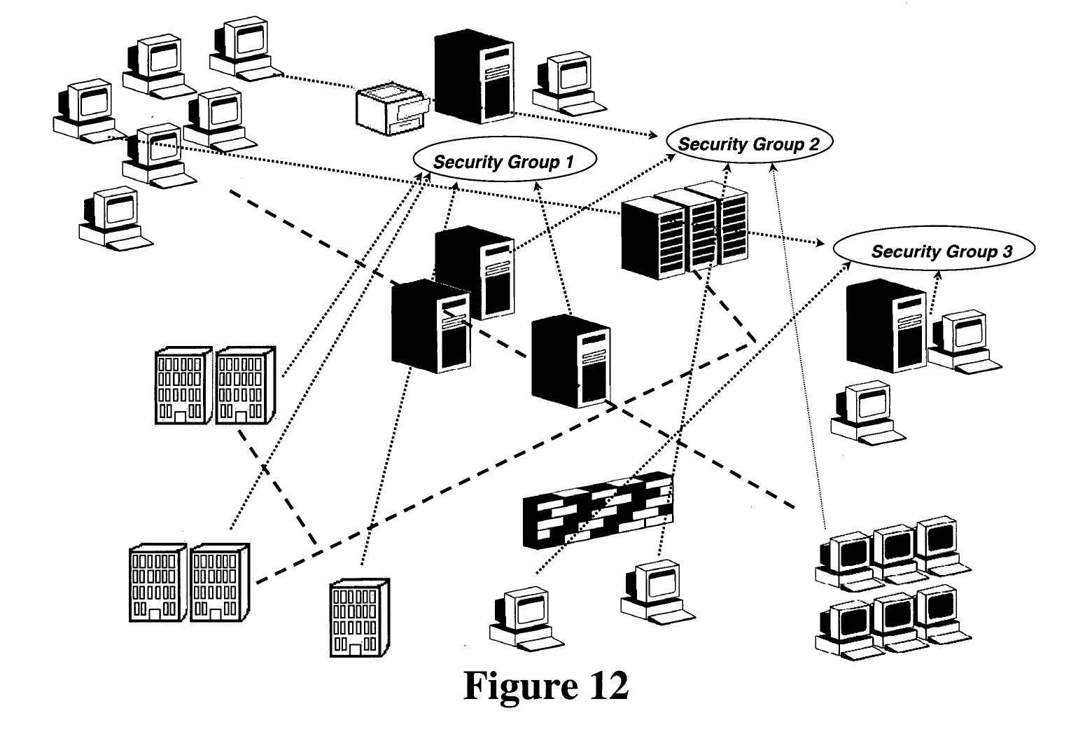

As set forth hereinabove, the system and methods of the present invention provide for functional, dynamic security groups on a given network both inside and outside organizational boundaries and across geographical locations. The result is a flexible security solution that is operable to be responsive to different security requirements for different groups of users and applications as illustrated in FIG. 12.

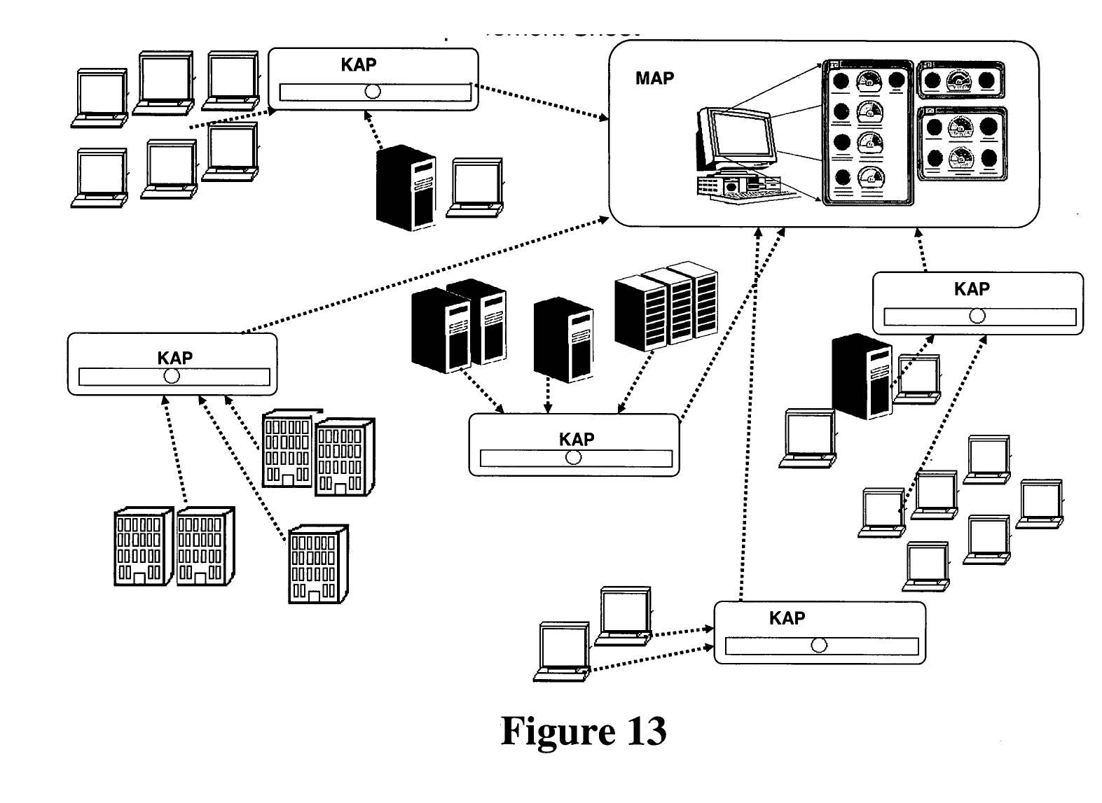

FIG. 13 illustrates security group enforcement via MAP/KAP.

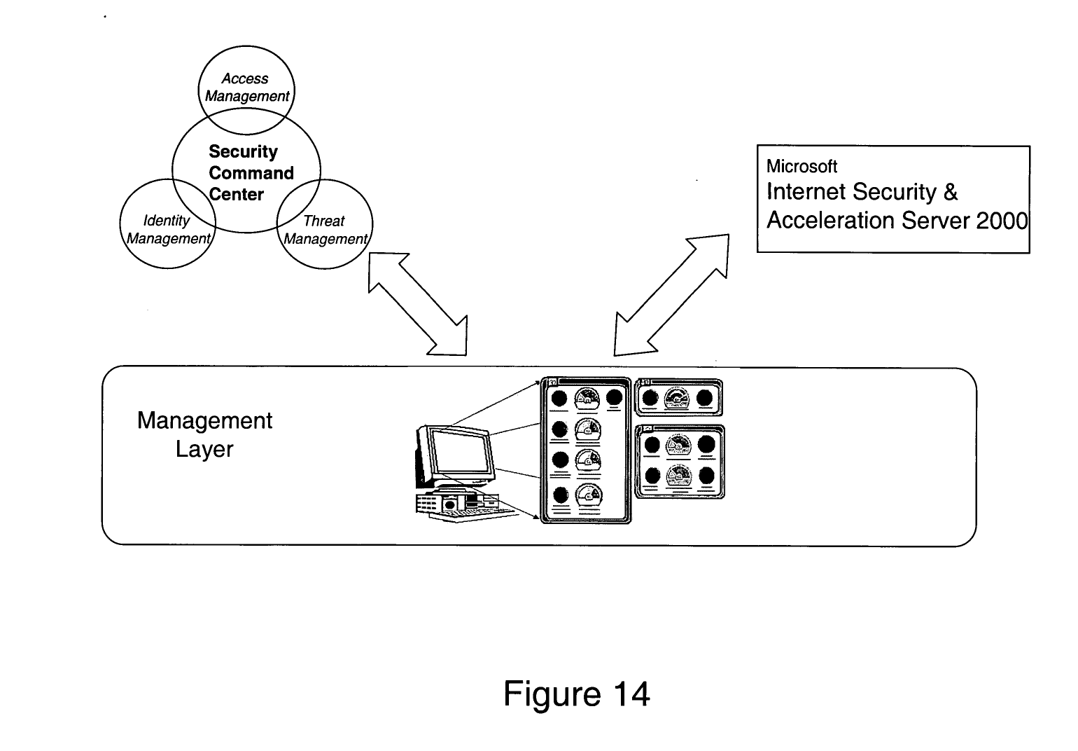

FIG. 14 shows a configuration having multiple integration points through APIs according to the present invention.

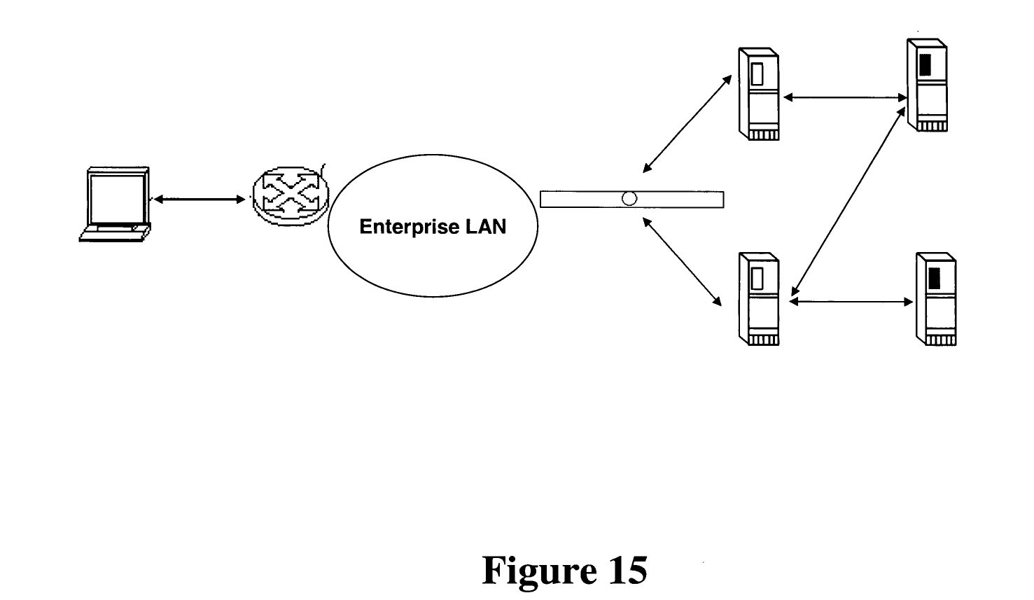

FIG. 15 illustrates security groups and data protection with NAC server for one application embodiment of the present invention.

Certain modifications and improvements will occur to those skilled in the art upon a reading of the foregoing description. The above mentioned examples and embodiments are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the following claims.

What is claimed is:

1. A system for providing secure networks comprising:
a communication network having a network infrastructure; and
an intelligent software overlay operating on a server in connection to the network for providing security for the network; wherein the intelligent software overlay further includes:
a management and policy (MAP) server coupled to the network for communication with at least one key authority point (KAP), wherein the MAP includes at least one policy for providing secure association (SA) within the network;
wherein the at least one KAP is operable to generate and manage keys provided to a multiplicity of policy end points (PEPs) through an open API;
and wherein the intelligent overlay to the network is independent of the network infrastructure and requires a minimum number of policies and SAs to create a full mesh, wherein the number of policies is less than N(N−1) and number of SAs is less than 2N(N−1), where N is the number of end points,
thereby providing a secure, flexible network security solution.

2. The system of claim 1, wherein the intelligent overlay is dynamically modifiable to reconfigure secure PEP interactivity without-requiring change to the network infrastructure.

3. The system of claim 1, wherein the system is scalable without increasing the number of policies and SAs required to create a full mesh.

4. The system of claim 1, wherein the number of policies is between 1 and less than N(N−1), and the corresponding number of SAs is between 2 and less than 2N(N−1).

5. A method for providing secure interactivity between points on a network comprising the steps of:
providing a communication network having a network infrastructure between a multiplicity of policy end points (PEPs);
providing an intelligent software overlay that is independent of the network infrastructure, the software overlay operating on a server in connection to the network for providing security for the network; wherein the intelligent software overlay further includes: a management and policy (MAP) server coupled to the network for communication with at least one key authority point (KAP);
the MAP establishing and managing at least one policy for providing secure association (SA) between PEPs within the network;
the KAP generating and managing keys and providing them to the PEPs through an open API;
and the PEPs having secure exchange over the network using the keys provided by the KAP;
wherein the intelligent overlay to the network is independent of the network infrastructure and requires a minimum number of policies and SAs to create a full mesh, wherein the number of policies is less than N(N−1) and number of SAs is less than 2N(N−1), where N is the number of end points.
